(19) United States
(12) Patent Application Publication
(10) Pub. No.: US 2026/0292110 A1
(43) Pub. Date: Sep. 24, 2026

(54) ELECTRONIC INSTRUMENT

(71) Applicant: SEIKO EPSON CORPORATION, Tokyo (JP)

(72) Inventors: Yosuke NAKATA, MATSUMOTO-SHI (JP); Keita TSUKIOKA, MATSUMOTO-SHI (JP); Toshio MATSUMIYA, MATSUMOTO-SHI (JP); Hiroyuki UMEDA, SHIOJIRI-SHI (JP)

(21) Appl. No.: 19/571,587

(22) Filed: Mar. 19, 2026

(30) Foreign Application Priority Data
Mar. 21, 2025 (JP) 2025-047384

(51) Int. Cl. H04N 9/31

(52) U.S. Cl. CPC H04N 9/3144; H04N 9/3105; H04N 9/3164

(57) ABSTRACT

An electronic instrument includes a first heat generator; a second heat generator; a first heat dissipating member configured to dissipate the heat generated by the first heat generator; a heat transporting member configured to transport the heat generated by the second heat generator; a second heat dissipating member configured to dissipate the heat transported by the heat transporting member; and a first fan configured to cause a first airflow. The first heat dissipating member is located upstream of the second heat dissipating member in a channel of the first airflow. An amount of the heat generated by the first heat generator is smaller than an amount of the heat generated by the second heat generator. A managed temperature of the first heat generator is lower than a managed temperature of the second heat generator. A portion of the second heat dissipating member overlaps with the first heat dissipating member.

### CROSS-REFERENCE TO RELATED APPLICATION

The present application is based on, and claims priority from JP Application Serial Number 2025-047384, filed Mar. 21, 2025, the disclosure of which is hereby incorporated by reference herein in its entirety.

### BACKGROUND

### 1. Technical Field

The present disclosure relates to an electronic instrument.

### 2. Related Art

There is a known projection illuminator of related art in which three types of color light emitted from three light emitting diodes are modulated by transmissive light modulating elements provided on a color basis, and the modulated three types of color light are combined with one another and projected (for example, refer to JP-A-2000-180962).

The projection illuminator described in JP-A-2000-180962 includes three light emitting diodes, three transmissive light modulating elements, a dichroic prism, and a projection lens. The three transmissive light modulating elements are disposed so as to face the three light incident surfaces of the dichroic prism, and the three light emitting diodes are each disposed so as to face the corresponding one of the three transmissive light modulating elements. The color light emitted from each of the light emitting diodes is modulated by the corresponding transmissive light modulating element, and is incident on the corresponding light incident surface of the dichroic prism. The dichroic prism combines the three types of color light with one another and outputs the combined light toward the projection lens. The projection lens projects the combined light from the dichroic prism.

JP-A-2000-180962 is an example of the related art.

In the projection illuminator described in JP-A-2000-180962, when a cooling apparatus is provided for each of the light emitting diodes and the light emitting diodes are each cooled by the corresponding cooling apparatus, there is a problem of an increase in the configuration of the projection illuminator.

In view of the problem described above, a configuration capable of reducing the size of the projection illuminator has been required.

### SUMMARY

An electronic instrument according to an aspect of the present disclosure includes a first heat generator configured to generate heat; a second heat generator configured to generate heat; a first heat dissipating member configured to dissipate the heat generated by the first heat generator; a heat transporting member configured to transport the heat generated by the second heat generator; a second heat dissipating member configured to dissipate the heat transported by the heat transporting member; and a first fan configured to cause a first airflow to flow along a first direction through the first and second heat dissipating members, the first heat dissipating member being located upstream of the second heat dissipating member in a channel of the first airflow, an amount of the heat generated by the first heat generator being smaller than an amount of the heat generated by the second heat generator, a managed temperature of the first heat generator being lower than a managed temperature of the second heat generator, and a portion of the second heat dissipating member overlapping with the first heat dissipating member in the first direction.

### BRIEF DESCRIPTION OF THE DRAWINGS

FIG. 1 is a perspective view showing a projector according to a first embodiment.

FIG. 2 is another perspective view showing the projector according to the first embodiment.

FIG. 3 is a plan view showing the internal structure of the projector according to the first embodiment.

FIG. 4 is a perspective view showing a red-channel heat dissipating member and a green-channel heat dissipating member according to the first embodiment.

FIG. 5 is a cross-sectional view of the projector taken at the position of an outlet port according to the first embodiment.

FIG. 6 is a diagrammatic view showing the flow direction of a first airflow according to the first embodiment.

FIG. 7 is a diagrammatic view showing a portion of a cooling apparatus provided in a projector according to a second embodiment.

### DESCRIPTION OF EMBODIMENTS

A first embodiment of the present disclosure will be described below with reference to the drawings.

### Schematic configuration of projector

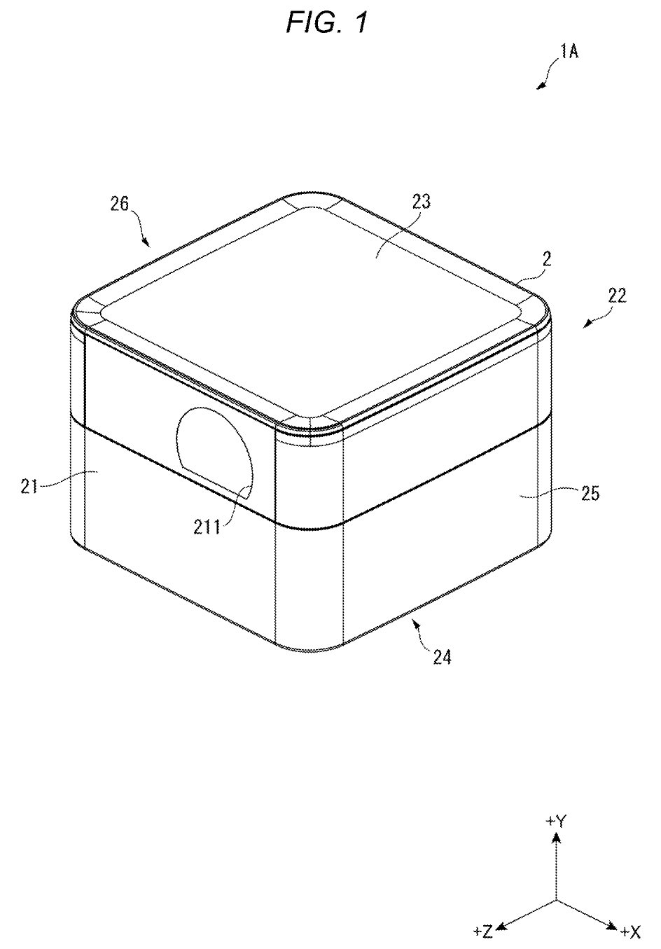

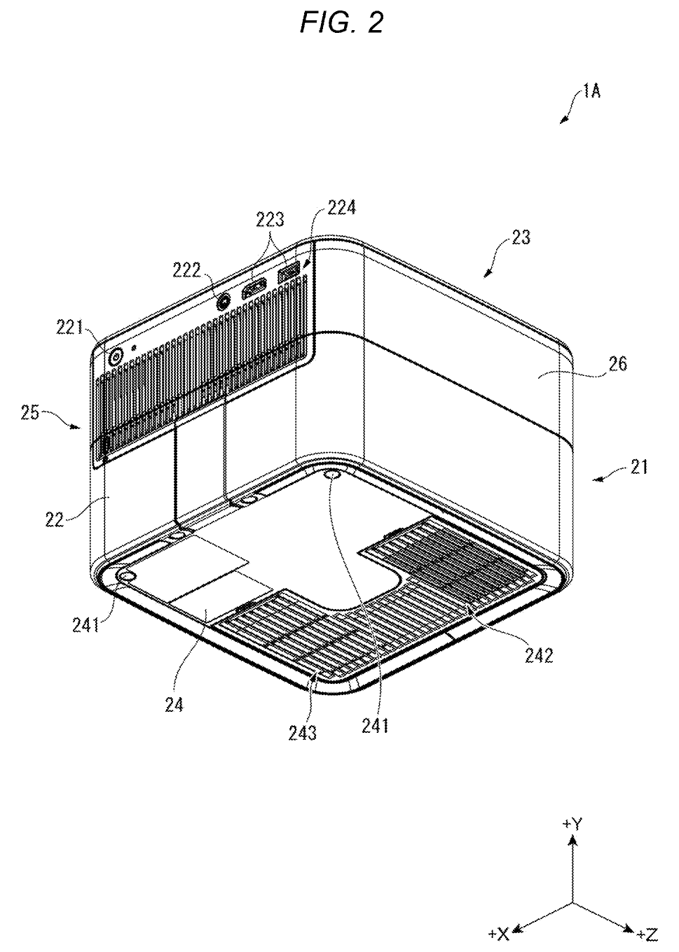

FIGS. 1 and 2 are perspective views showing a projector 1A according to the present embodiment. FIG. 1 is a perspective view of the projector 1A viewed from the side facing a front surface 21, and FIG. 2 is a perspective view of the projector 1A viewed from the side facing a rear surface 22.

The projector 1A according to the present embodiment is an electronic instrument that forms and projects image light according to image information. The projector 1A includes an exterior enclosure 2, which constitutes the exterior of the projector 1A, as shown in FIGS. 1 and 2.

The configuration of the projector 1A will be described below.

### Configuration of exterior enclosure

The exterior enclosure 2 is made, for example, of synthetic resin and has a substantially cuboidal shape. The exterior enclosure 2 has the front surface 21, the rear surface 22, a top surface 23, a bottom surface 24, a right side surface 25, and a left side surface 26.

The front surface 21 and the rear surface 22 are surfaces facing opposite sides. The front surface 21 has a projection port 211, and image light projected from a projection optical apparatus 36, which will be described later, of an image projection apparatus 3 passes through the projection port 211, as shown in FIG. 1. The rear surface 22 includes a power button 221, a terminal 222, to which an earphone can be coupled, and multiple terminals 223, to each of which a video cable can be coupled, as shown in FIG. 2. In addition, the rear surface 22 has an exhaust port 224, via which an airflow having flowed in the exterior enclosure 2 is discharged.

The top surface 23 and the bottom surface 24 are surfaces facing opposite sides. The bottom surface 24 is a surface facing an installation surface, and the bottom surface 24 is provided with multiple legs 241, which are in contact with the installation surface, and inlet ports 242 and 243, via which an external gas is introduced into the exterior enclosure 2. The gas introduced into the exterior enclosure 2 via the inlet port 242 and the gas introduced into the exterior enclosure 2 via the inlet port 243 are caused to flow into different cooling channels. In the present embodiment, the gas introduced into the exterior enclosure 2 via the inlet port 242 is supplied to a first cooling system 4A including a first fan 44, which will be described later. The gas introduced into the exterior enclosure 2 via the inlet port 243 is supplied to a second cooling system 4B including a second fan 47, which will be described later.

Note that a stand that supports the projector 1A and can be used to adjust the projection angle of the image light may be attached to the bottom surface 24. In this case, the stand may have a configuration in which a gap is formed between the installation surface and the bottom surface 24 while the projector 1A projects the image light at any projection angle.

The right side surface 25 and the left side surface 26 are surfaces facing opposite sides.

In the following description, three directions perpendicular to each another are called a +X direction, a +Y direction, and a +Z direction. It is assumed in the present embodiment that the +Z direction is the direction from the rear surface 22 toward the front surface 21, that the +Y direction is the direction from the bottom surface 24 toward the top surface 23, and that the +X direction is the direction from the left side surface 26 toward the right side surface 25. The projector 1A projects the image light in the +Z direction when viewed in the +Y direction.

Although not shown in the drawings, the direction opposite the +Z direction is called a −Z direction, the direction opposite the +Y direction is called a −Y direction, and the direction opposite the +X direction is called a −X direction. An axis along the ±Z direction is called a Z-axis, an axis along the ±Y direction is called a Y-axis, and an axis along the ±X direction is called an X-axis.

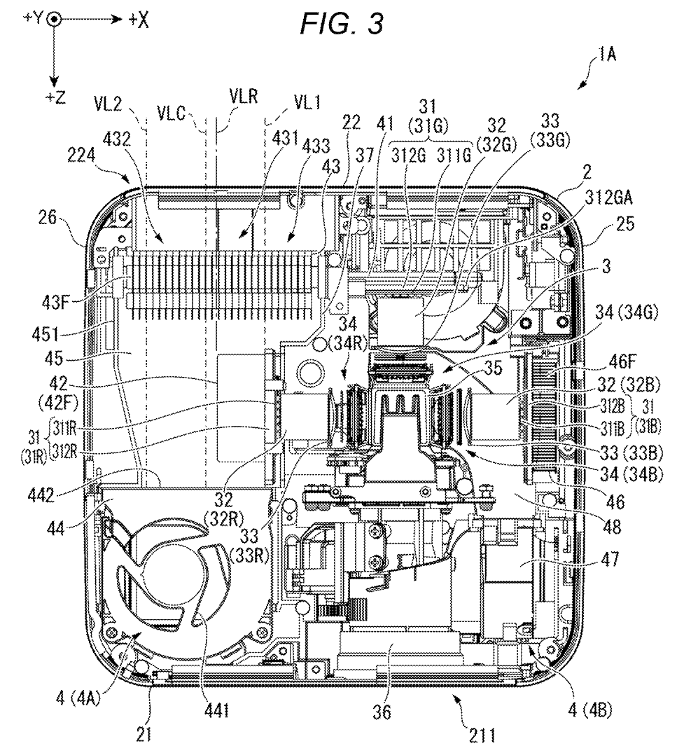

FIG. 3 is a plan view showing the interior of the exterior enclosure 2. That is, FIG. 3 is a plan view showing the internal structure of the projector 1A.

The projector 1A further includes the image projection apparatus 3 and a cooling apparatus 4, which are housed in the exterior enclosure 2, as shown in FIG. 3. Although not shown in the drawings, the projector 1A further includes a controller that controls the operation of the projector 1A, and a power supply apparatus that supplies electronic parts of the projector 1A with electric power. Note that the controller and the power supply apparatus may not necessarily be provided in the projector 1A, and that the power supply apparatus may be provided, for example, outside the projector 1A.

### Configuration of image projection apparatus

The image projection apparatus 3 forms image light and projects the image light out of the exterior enclosure 2 via the projection port 211. The image projection apparatus 3 includes a light source apparatus 31, a light guide element 32, a parallelizing element 33, a light modulator 34, a light combiner 35, a projection optical apparatus 36, and a partitioner 37.

The light source apparatus 31 outputs light with which the light modulator 34 is illuminated. The light source apparatus 31 includes a red light source 31R, which outputs red light, a green light source 31G, which outputs green light, and a blue light source 31B, which outputs blue light.

The red light source 31R includes a red LED (light emitting diode) 311R, which emits the red light in the +X direction, and a substrate 312R, which supports the red LED 311R. The red light source 31R outputs the red light to a red light guide element 32R of the light guide element 32.

The green light source 31G includes a green LED 311G, which emits the green light in the +Z direction, which intersects with the +X direction, and a substrate 312G, which supports the green LED 311G. The green light source 31G outputs the green light to a green light guide element 32G of the light guide element 32.

The blue light source 31B includes a blue LED 311B, which emits the blue light in the −X direction, and a substrate 312B, which supports the blue LED 311B. The blue light source 31B outputs the blue light to a blue light guide element 32B of the light guide element 32.

Note that the red LED 311R corresponds to a first heat generator, the green LED 311G corresponds to a second heat generator, and the blue LED 311B corresponds to a third heat generator.

The red LED 311R, the green LED 311G, and the blue LED 311B each generate heat when emitting the corresponding color light. The amount of the heat generated by the red LED 311R is smaller than the amount of the heat generated by the green LED 311G but greater than the amount of the heat generated by the blue LED 311B. A managed temperature of the red LED 311R is lower than a managed temperature of each of the green LED 311G and the blue LED 311B. The managed temperature of the blue LED 311B is lower than the managed temperature of the green LED 311G.

That is, the amount of the heat generated by the green LED 311G > the amount of the heat generated by the red LED 311R > the amount of the heat generated by the blue LED 311B, and the managed temperature of the green LED 311G > the managed temperature of the blue LED 311B > the managed temperature of the red LED 311R. A cooling difficulty of the red LED 311R > a cooling difficulty of the green LED 311G > a cooling difficulty of the blue LED 311B. Therefore, in the present embodiment, the LEDs are so grouped that the red LED 311R and the green LED 311G, which each have a high cooling difficulty, are each cooled by the first cooling system 4A, which will be described later, and the blue LED 311B, which has a low cooling difficulty, is cooled by the second cooling system 4B, which will be described later. Although this will be described later in detail, a small number of targets are cooled by the first cooling system 4A, and a large number of targets are cooled by the second cooling system 4B. The cooling difficulty indicates a difficulty in cooling, and specifically, the high cooling difficulty indicates that the necessity of cooling is high.

A red-channel heat dissipating member 42, which constitutes the cooling apparatus 4, is coupled in a heat transferable manner to a surface of the substrate 312R that is the surface opposite the red LED 311R.

A blue-channel heat dissipating member 46, which constitutes the cooling apparatus 4, is coupled in a heat transferable manner to a surface of the substrate 312B that is the surface opposite the blue LED 311B.

A heat transporting member 41, which constitutes the cooling apparatus 4, is coupled in a heat transferable manner to a surface of the substrate 312G that is the surface opposite the green LED 311G, and a green-channel heat dissipating member 43 is coupled in a heat transferable manner to an end of the heat transporting member 41 that is the end opposite the substrate 312G.

The heat of the light sources 31R, 31G, and 31B, which is generated by the LEDs 311R, 311G, and 311B, is thus dissipated by the cooling apparatus 4.

The light guide element 32 is formed in a substantially truncated quadrangular pyramidal shape and guides the light output from the light source apparatus 31 to the light modulator 34. The light guide element 32 includes the red light guide element 32R, which guides the red light, the green light guide element 32G, which guides the green light, and the blue light guide element 32B, which guides the blue light.

The red light guide element 32R homogenizes the illuminance of the red light emitted from the red LED 311R, and guides the red light to a red light modulating element 34R of the light modulator 34.

The green light guide element 32G homogenizes the illuminance of the green light emitted from the green LED 311G, and guides the green light to a green light modulating element 34G of the light modulator 34.

The blue light guide element 32B homogenizes the illuminance of the blue light emitted from the blue LED 311B, and guides the blue light to a blue light modulating element 34B of the light modulator 34.

The parallelizing element 33 is what is called a field lens disposed between the light guide element 32 and the light modulator 34. The parallelizing element 33 includes a red light parallelizing element 33R provided in the optical path of the red light, a green light parallelizing element 33G provided in the optical path of the green light, and a blue light parallelizing element 33B provided in the optical path of the blue light.

The parallelizing elements 33R, 33G, and 33B each parallelize the color light incident thereon and output the parallelized color light. For example, the red light parallelizing element 33R parallelizes the red light incident from the red light guide element 32R, and outputs the parallelized red light to the red light modulating element 34R of the light modulator 34. The same holds true for the green light parallelizing element 33G and the blue light parallelizing element 33B.

The light modulator 34 modulates the light incident from the light source apparatus 31 via the light guide element 32 and the parallelizing element 33. The light modulator 34 includes the red light modulating element 34R, the green light modulating element 34G, and the blue light modulating element 34B.

The red light modulating element 34R is a first image generating element that modulates the red light to generate red image light. The red light corresponds to first light, and the red image light corresponds to first image light.

The green light modulating element 34G is a second image generating element that modulates the green light to generate green image light. The green light corresponds to second light, and the green image light corresponds to second image light.

The blue light modulating element 34B is a third image generating element that modulates the blue light to generate blue image light. The blue light corresponds to third light, and the blue image light corresponds to third image light.

The light modulating elements 34R, 34G, and 34B can each, for example, be a transmissive liquid crystal light valve including a liquid crystal panel, a light-incident-side polarizer, and a light-exiting-side polarizer the latter two of which sandwich the liquid crystal panel.

The light combiner 35 combines the red light modulated by the red light modulating element 34R, the green light modulated by the green light modulating element 34G, and the blue light modulated by the blue light modulating element 34B with one another to form image light to be projected by the projection optical apparatus 36. The light combiner 35 outputs the formed image light toward the projection optical apparatus 36. The thus functioning light combiner 35 can, for example, be a cross dichroic prism formed in a substantially cuboidal shape.

The projection optical apparatus 36 is one of optical parts and projects the image light output from the light combiner 35. The image light projected by the projection optical apparatus 36 is projected onto a projection receiving surface such as a screen via the projection port 211. The thus functioning projection optical apparatus 36 can, for example, be a lens assembly including multiple lenses and a lens barrel that houses the multiple lenses.

The partitioner 37 couples the red light source 31R and the green light source 31G to each other to separate the image projection apparatus 3 from the red-channel heat dissipating member 42 and the green-channel heat dissipating member 43, which will be described later, of the cooling apparatus 4. In addition, the partitioner 37 has the function of guiding a first airflow having flowed through the red-channel heat dissipating member 42 to the green-channel heat dissipating member 43. That is, the partitioner 37 constitutes a portion of a first duct 45, which will be described later.

### Configuration of cooling apparatus

The cooling apparatus 4 cools cooling targets of the projector 1A. The cooling apparatus 4 includes the heat transporting member 41, the red-channel heat dissipating member 42, the green-channel heat dissipating member 43, the first fan 44, the first duct 45, the blue-channel heat dissipating member 46, the second fan 47, and a second duct 48.

The heat transporting member 41, the red-channel heat dissipating member 42, the green-channel heat dissipating member 43, the first fan 44, and the first duct 45 constitute the first cooling system 4A, which cools each of the red LED 311R of the red light source 31R and the green LED 311G of the green light source 31G.

The blue-channel heat dissipating member 46, the second fan 47, and the second duct 48 constitute the second cooling system 4B, which cools the blue LED 311B of the blue light source 31B and the light modulating elements 34R, 34G, and 34B.

### Configuration of second cooling system

The second cooling system 4B will first be described.

The blue-channel heat dissipating member 46 corresponds to a third heat dissipating member, and is coupled in a heat transferable manner to a surface of the substrate 312B of the blue light source 31B that is the surface opposite the blue LED 311B. The blue-channel heat dissipating member 46 dissipates heat transferred from the blue LED 311B via the substrate 312B.

The blue-channel heat dissipating member 46 includes multiple fins 46F.

The multiple fins 46F are each formed in a plate-like shape along an XY plane defined by the X-axis and the Y-axis. The blue-channel heat dissipating member 46 is configured with the multiple fins 46F arranged along the Z-axis and linked to each other. An airflow generated by the second fan 47 flows in the +Y direction between the multiple fins 46F.

The second fan 47 causes a second airflow to flow to the light modulating elements 34R, 34G, and 34B and the blue-channel heat dissipating member 46. The second airflow is an airflow caused to flow by the second fan 47.

In the present embodiment, the second fan 47 is configured with a sirocco fan, and is disposed at a position shifted from the projection optical apparatus 36 in the +X direction in the exterior enclosure 2. The second fan 47 suctions the gas in the exterior enclosure 2, sends the suctioned gas into the second duct 48, and causes the second airflow to flow to the light modulating elements 34R, 34G, and 34B and the blue-channel heat dissipating member 46 via the second duct 48.

The second duct 48 is disposed at a position shifted in the −Y direction from the light modulator 34 and the light combiner 35. The second duct 48 divides the second airflow sent from the second fan 47 and causes the divided portion to flow in the −Y direction to the light modulating elements 34R, 34G, and 34B and the blue-channel heat dissipating member 46. The light modulating elements 34R, 34G, and 34B and the blue LED 311B are thus cooled. Note that the second airflow flowing to the light modulating elements 34R, 34G, and 34B and the blue LED 311B is discharged out of the exterior enclosure 2 via the exhaust port 224. Note that a sirocco fan or the like as an exhaust fan may be disposed at a position shifted in the −Y direction from the green light source 31G so that the airflow can be efficiently discharged out of the exterior enclosure 2. Disposing the exhaust fan at a position shifted in the −Y direction from the optical system including the green light source 31G can suppress an increase in the area of the projector 1A along an XZ plane.

### Configuration of first cooling system

### Configuration of heat transporting member

The heat transporting member 41 is coupled to a surface 312GA of the substrate 312G of the green light source 31G that is the surface opposite the green LED 311G. The surface 312GA is one of the surfaces of the substrate 312G and is perpendicular to the Z-axis. That is, the surface 312GA is parallel to a plane defined by the X-axis and the Y-axis.

The heat transporting member 41 extends linearly in the −X direction along the surface 312GA. The +X-side end of the heat transporting member 41 is a heat receiving end coupled to the surface 312GA of the substrate 312G, and the −X-side end of the heat transporting member 41 is a heat dissipating end coupled to the green-channel heat dissipating member 43. The heat transporting member 41 transports the heat of the green LED 311G received from the substrate 312G to the green-channel heat dissipating member 43.

In the present embodiment, the heat transporting member 41 is coupled to the surface 312GA and may instead be coupled to a surface of the substrate 312G that is the surface where the green LED 311G is provided.

### Configuration of red-channel heat dissipating member

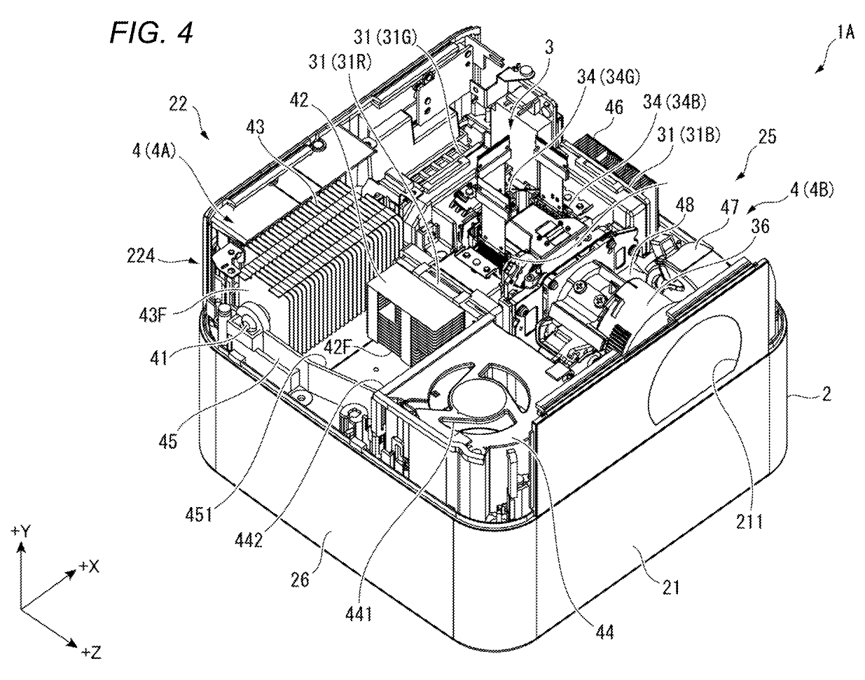

FIG. 4 is a perspective view showing the red-channel heat dissipating member 42 and the green-channel heat dissipating member 43.

The red-channel heat dissipating member 42 corresponds to a first heat dissipating member and is coupled in a heat transferable manner to a surface of the substrate 312R of the red light source 31R that is the surface opposite the red LED 311R. The red-channel heat dissipating member 42 dissipates heat transferred from the red LED 311R via the substrate 312R. The red-channel heat dissipating member 42 includes multiple fins 42F. The fins 42F correspond to first fins.

The multiple fins 42F are each formed in a plate-like shape along the XZ plane defined by the −Z direction, which is the flowing direction of the airflow, and the −X direction perpendicular to the −Z direction. The red-channel heat dissipating member 42 is configured with the multiple fins 42F arranged in the +Y direction perpendicular to each of the −Z direction and the −X direction and linked to each other. The first fan 44 causes the first airflow to flow in the −Z direction between the multiple fins 42F.

Note that the −Z direction corresponds to a first direction, that the −X direction corresponds to a second direction, and that the +Y direction corresponds to a third direction.

### Configuration of green-channel heat dissipating member

The green-channel heat dissipating member 43 shown in FIG. 3 corresponds to a second heat dissipating member and is provided at the heat dissipation end of the heat transporting member 41. The green-channel heat dissipating member 43 is disposed at a position shifted in the −Z direction from the red-channel heat dissipating member 42. In other words, the green-channel heat dissipating member 43 is disposed downstream of the red-channel heat dissipating member 42 in the channel of the airflow generated by the first fan 44. The green-channel heat dissipating member 43 dissipates the heat of the green LED 311G transferred via the heat transporting member 41 to the first airflow.

The green-channel heat dissipating member 43 includes multiple fins 43F. The fins 43F correspond to second fins.

The multiple fins 43F are each formed in a plate-like shape along a YZ plane defined by the −Z direction and the +Y direction perpendicular to the −Z direction, as shown in FIGS. 3 and 4. The green-channel heat dissipating member 43 is configured with the multiple fins 43F provided at the outer circumferential surface of the heat transporting member 41 and arranged in the −X direction perpendicular to each of the −Z direction and the +Y direction. The first fan 44 causes the first airflow to flow in the −Z direction between the multiple fins 43F, and the first airflow having flowed between the multiple fins 43F is discharged out of the exterior enclosure 2 via the exhaust port 224.

The green-channel heat dissipating member 43 does not necessarily have the configuration in which the multiple fins 43F provided at the outer circumferential surface of the heat transporting member 41 are linked to each other by the heat transporting member 41, and a coupler that couples the multiple fins 43F to each other may be coupled to the heat transporting member 41.

The green-channel heat dissipating member 43 includes a first region 431, a second region 432, and a third region 433.

The first region 431 is a region facing the red-channel heat dissipating member 42 in the −Z direction. That is, the red-channel heat dissipating member 42 is disposed between the first fan 44 and the first region 431 in the +Z direction.

The second region 432 is a region located at a position shifted from the first region 431 in the −X direction, and is a region facing an outlet port 442, which will be described later, of the first fan 44 in the −Z direction. Nothing is disposed between the outlet port 442 and the second region 432 in the −Z direction. The surface area of the second region 432 is greater than the surface area of the first region 431.

The third region 433 is a region located at a position shifted from the first region 431 in the +X direction. The third region 433 faces neither the red-channel heat dissipating member 42 in the −Z direction nor the outlet port 442 in the −Z direction. The surface area of the third region 433 is substantially equal to the surface area of the first region 431 and is smaller than the surface area of the second region 432. The total surface area of the surface area of the first region 431 and the surface area of the third region 433 is greater than the surface area of the second region 432.

### Comparison between red-channel heat dissipating member and green-channel heat dissipating member

The configuration of the red-channel heat dissipating member 42 and the configuration of the green-channel heat dissipating member 43 will now be compared with each other.

The surface area of the red-channel heat dissipating member 42 is smaller than the surface area of the green-channel heat dissipating member 43.

The intervals at which the fins 42F of the red-channel heat dissipating member 42 are arranged differ from the intervals at which the fins 43F of the green-channel heat dissipating member 43 are arranged. In detail, the intervals at which the fins 42F are arranged are smaller than the intervals at which the fins 43F are arranged.

The number of the fins 42F of the red-channel heat dissipating member 42 is smaller than the number of the fins 43F of the green-channel heat dissipating member 43.

### Configuration of first fan

The first fan 44 causes the first airflow to flow to the red-channel heat dissipating member 42 and the green-channel heat dissipating member 43. The first airflow is an airflow caused to flow by the first fan 44.

In the present embodiment, the first fan 44 is disposed at a position shifted in the +Z direction from the red-channel heat dissipating member 42 and the green-channel heat dissipating member 43. In other words, in the channel of the airflow sent by the first fan 44, the red-channel heat dissipating member 42 is located upstream of the green-channel heat dissipating member 43, and the first fan 44 is located further upstream of the red-channel heat dissipating member 42.

The first fan 44 is a centrifugal fan having an intake port 441 and the outlet port 442.

The intake port 441 suctions the gas introduced into the exterior enclosure 2 via the inlet port 242. The intake port 441 is provided at each of the +Y-side surface of the first fan 44 and the −Y-side surface of the first fan 44. That is, the first fan 44 is a double-intake-sided centrifugal fan. The first fan 44 is, however, not limited thereto and may be a single-intake-sided centrifugal fan having the intake port 441, for example, only at the −Y-side surface. The centrifugal fan may be a turbofan or a sirocco fan.

The outlet port 442 is provided at the −Z-side surface of the first fan 44, and the gas suctioned via the intake port 441 is sent via the outlet port 442. The first fan 44 sends a cooling gas via the outlet port 442 in the −Z direction to generate the first airflow flowing to the red-channel heat dissipating member 42 and the green-channel heat dissipating member 43.

The first duct 45 guides the first airflow caused to flow by the first fan 44 to the red-channel heat dissipating member 42 and the green-channel heat dissipating member 43. Specifically, the first duct 45 houses the red-channel heat dissipating member 42, the green-channel heat dissipating member 43, and the first fan 44, and causes the first airflow sent from the first fan 44 to the red-channel heat dissipating member 42 and the green-channel heat dissipating member 43.

The first duct 45 includes a guide 451 configured with the +X-side inner surface out of the inner surfaces of the first duct 45, as shown in FIG. 3. The guide 451 guides the first airflow sent via the outlet port 442 to the second region 432 of the green-channel heat dissipating member 43. The +Z-side end of the guide 451 is coupled to the outlet port 442, and the −Z-side end of the guide 451 extends to a −X-side portion of the green-channel heat dissipating member 43. The guide 451 therefore extends in the −X direction, which is a direction away from the red-channel heat dissipating member 42 and the green-channel heat dissipating member 43, as extending in the −Z direction, which is the flowing direction of the airflow, and the guide 451 covers the heat transporting member 41 and the green-channel heat dissipating member 43 when viewed in the −X direction. A portion of the first airflow sent via the outlet port 442 is thus readily caused to flow to the second region 432.

### Positional relationship between outlet port and red-channel and green-channel heat dissipating members

A virtual line passing through the +X-side end of the outlet port 442 and extending in the −Z direction when viewed in the +Y direction is called a first virtual line VL1, as shown in FIG. 3. A virtual line passing through the center of the outlet port 442 in the +X direction and extending in the −Z direction when viewed in the +Y direction is called a center virtual line VLC. A virtual line passing through the −X-side end of the outlet port 442 and extending in the −Z direction is called a second virtual line VL2.

The red-channel heat dissipating member 42 is disposed between the first virtual line VL1 and the second virtual line VL2. In detail, the red-channel heat dissipating member 42 is disposed between the first virtual line VL1 and the center virtual line VLC. In the present embodiment, the +X-side end of the red-channel heat dissipating member 42 is located on the first virtual line VL1. A virtual line VLR passing through the −X-side end of the red-channel heat dissipating member 42 and parallel to the −Z direction is located between the first virtual line VL1 and the center virtual line VLC.

The green-channel heat dissipating member 43 extends beyond the second virtual line VL2 toward the side opposite the first virtual line VL1 with the second virtual line VL2 therebetween. That is, the green-channel heat dissipating member 43 extends in the +X direction beyond the first virtual line VL1 and further extends in the −X direction beyond the second virtual line VL2. As described above, the guide 451 of the first duct 45 extends in the −X direction as extending in the −Z direction, and covers the green-channel heat dissipating member 43 when viewed in the −X direction.

### First airflow caused to flow by first fan

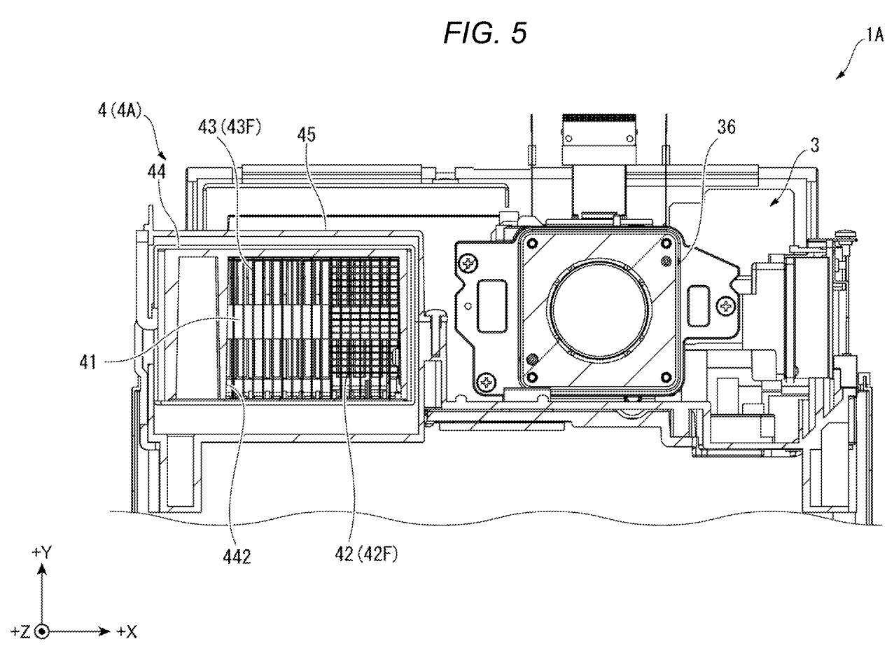

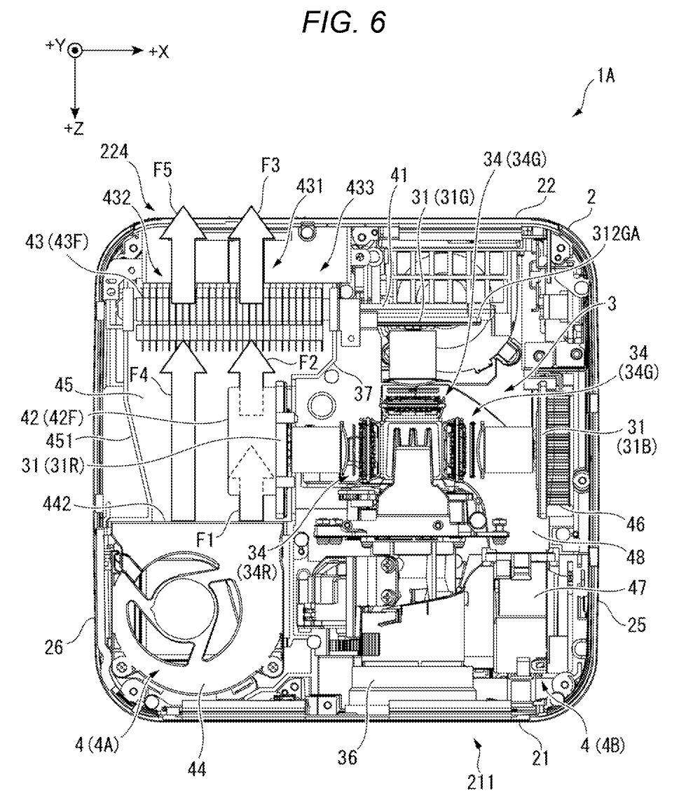

FIG. 5 shows a cross section of the projector 1A taken along the XY plane at the position of the outlet port 442 when viewed in the +Z direction. That is, FIG. 5 shows the positional relationship of the outlet port 442 with the red-channel heat dissipating member 42 and the green-channel heat dissipating member 43. Note that FIG. 5 does not show a portion of the exterior enclosure 2. FIG. 6 is a diagrammatic view showing the flowing direction of the first airflow sent via the outlet port 442.

When viewed from the outlet port 442, the red-channel heat dissipating member 42 is disposed in the outlet port 442, and a portion of the second region 432 of the green-channel heat dissipating member 43 is disposed in the outlet port 442, as shown in FIG. 5.

Therefore, a first airflow F1 sent from a +X-side region of the outlet port 442 out of the first airflow sent in the −Z direction via the outlet port 442 directly flows to the red-channel heat dissipating member 42, as shown in FIG. 6. The first airflow F1 having flowed to the red-channel heat dissipating member 42 flows between the multiple fins 42F in the −Z direction to cool the red-channel heat dissipating member 42. A first airflow F2 having cooled the red-channel heat dissipating member 42 further flows in the −Z direction to the first region 431 of the green-channel heat dissipating member 43, which is the region facing the red-channel heat dissipating member 42, and the third region 433 of the green-channel heat dissipating member 43, which is the region located at a position shifted from the first region 431 in the +X direction.

The first airflow F2 having flowed to the first region 431 and the third region 433 flows in the −Z direction between the multiple fins 43F in the regions 431 and 433 to cool the regions 431 and 433. A first airflow F3 having cooled the regions 431 and 433 further flows in the −Z direction and is discharged out of the exterior enclosure 2 via the exhaust port 224 provided at the rear surface 22.

A first airflow F4 sent from a −X-side region of the outlet port 442 out of the first airflow sent in the −Z direction via the outlet port 442 directly flows to the second region 432 of the green-channel heat dissipating member 43. The first airflow F4 having flowed to the second region 432 flows in the −Z direction between the multiple fins 43F in the second region 432 to cool the green-channel heat dissipating member 43. A first airflow F5 having cooled the second region 432 further flows in the −Z direction, and is discharged out of the exterior enclosure 2 via the first region 431 of the green-channel heat dissipating member 43, which is the region facing the red-channel heat dissipating member 42, and the exhaust port 224, as the airflow having cooled the regions 431 and 433.

### Advantages of first embodiment

The projector 1A according to the present embodiment described above provides the advantages below.

The projector 1A is an electronic instrument. The projector 1A includes the red light source 31R, the green light source 31G, the heat transporting member 41, the red-channel heat dissipating member 42, the green-channel heat dissipating member 43, and the first fan 44.

The red light source 31R includes the red LED 311R, which generates heat when lit, and the red LED 311R corresponds to the first heat generator. The green light source 31G includes the green LED 311G, which generates heat when lit, and the green LED 311G corresponds to the second heat generator. The red-channel heat dissipating member 42 dissipates the heat generated by the red LED 311R. The heat transporting member 41 transports the heat generated by the green LED 311G. The green-channel heat dissipating member 43 dissipates the heat of the green LED 311G transported by the heat transporting member 41. The first fan 44 causes the first airflow to flow along the −Z direction through the red-channel heat dissipating member 42 and the green-channel heat dissipating member 43. The −Z direction corresponds to the first direction. The red-channel heat dissipating member 42 is located upstream of the green-channel heat dissipating member 43 in the channel of the first airflow. The amount of the heat generated by the red LED 311R is smaller than the amount of the heat generated by the green LED 311G, and the managed temperature of the red LED 311R is lower than the managed temperature of the green LED 311G.

A portion of the green-channel heat dissipating member 43 overlaps with the red-channel heat dissipating member 42 in the −Z direction.

According to the configuration described above, the first airflow having a relatively low temperature can be caused to flow to the red-channel heat dissipating member 42, which dissipates the heat of the red LED 311R, which generates a small amount of heat and has a low managed temperature. The red-channel heat dissipating member 42 and in turn the red LED 311R can thus be effectively cooled.

A portion of the green-channel heat dissipating member 43 overlaps with the red-channel heat dissipating member 42 in the −Z direction, which is the flowing direction of the first airflow, but the other portion of the green-channel heat dissipating member 43 does not overlap with the red-channel heat dissipating member 42 in the −Z direction. Therefore, a portion of the first airflow flows to the green-channel heat dissipating member 43 via the red-channel heat dissipating member 42, and the other portion of the first airflow flows to the green-channel heat dissipating member 43 without passing through the red-channel heat dissipating member 42. As a result, the cooling efficiency of the green-channel heat dissipating member 43 and in turn the efficiency at which the green LED 311G is cooled can be increased as compared with a case where only the first airflow having flowed to the red-channel heat dissipating member 42 flows to the green-channel heat dissipating member 43.

The heat dissipating members 42 and 43 can therefore each be effectively cooled by the single fan, so that the size of the projector 1A as the electronic instrument can be reduced as compared with a case where multiple fans are provided in accordance with the heat dissipating members 42 and 43. In addition, the number of the fans can be reduced, so that the manufacturing cost of the projector 1A can be reduced.

In the projector 1A, the green-channel heat dissipating member 43 has the first region 431, which overlaps with the red-channel heat dissipating member 42 in the −Z direction, and the second region 432, which does not overlap with the red-channel heat dissipating member 42 in the −Z direction. The surface area of the second region 432 is greater than the surface area of the first region 431.

A portion of the first airflow flows to the first region 431 via the red-channel heat dissipating member 42, and the other portion of the first airflow flows to the second region 432 without passing through the red-channel heat dissipating member 42.

According to the configuration described above, the second region 432 having a surface area greater than the surface area of the first region 431 can be cooled by the first airflow having a low temperature, so that the cooling efficiency of the green-channel heat dissipating member 43 can be increased as compared with a case where the surface area of the second region 432 is smaller than or equal to the surface area of the first region 431. The cooling efficiency of the green-channel heat dissipating member 43 and in turn the efficiency at which the green LED 311G is cooled can therefore be increased.

In the projector 1A, the first fan 44 is disposed upstream of the red-channel heat dissipating member 42 and the green-channel heat dissipating member 43 in the channel of the first airflow. The first airflow sent from the first fan 44 directly flows to the second region 432.

The configuration described above allows the first airflow having a low temperature to flow to the second region 432 as compared with a case where another heat generator or another heat dissipating member is disposed between the first fan 44 and the second region 432. The cooling efficiency of the green-channel heat dissipating member 43 and in turn the efficiency at which the green LED 311G is cooled can therefore be increased.

The projector 1A includes the guide 451, which extends along the −Z direction and guides the first airflow to the green-channel heat dissipating member 43. The first fan 44 has the outlet port 442, via which the first airflow is sent. The first fan 44 is disposed upstream of the red-channel heat dissipating member 42 and the green-channel heat dissipating member 43 in the channel of the first airflow. The guide 451 couples a portion of a side of the outlet port 442 to a portion at the periphery of the second region 432.

According to the configuration described above, the first airflow sent via the outlet port 442 can be readily caused to flow to the second region 432. The cooling efficiency of the green-channel heat dissipating member 43 can therefore be increased as compared with a case where the guide 451 is not provided.

In the projector 1A, the red-channel heat dissipating member 42 is disposed between the first virtual line VL1, which extends in the −Z direction from the +X-side end of the outlet port 442, and the second virtual line VL2, which extends in the −Z direction from the −X-side end of the outlet port 442. The green-channel heat dissipating member 43 extends beyond the second virtual line VL2 toward the side opposite the first virtual line VL1 with the second virtual line VL2 therebetween. The +X-side end of the outlet port 442 corresponds to one end of the outlet port 442, and the −X-side end of the outlet port 442 corresponds to the other end of the outlet port 442.

The guide 451 extends toward the side opposite the first virtual line VL1 with the second virtual line VL2 therebetween as extending in the −Z direction. That is, the guide 451 extends in the −X direction as extending in the −Z direction.

According to the configuration described above, the green-channel heat dissipating member 43 can be elongated in the −X direction, which intersects with each of the virtual lines VL1 and VL2. The second region 432 can thus be extended in the −X direction, so that the surface area of the second region 432 can be readily increased.

Furthermore, since the guide 451 extends as described above, the first airflow sent via the outlet port 442 can be readily caused to flow to the green-channel heat dissipating member 43, which extends beyond the second virtual line VL2 toward the side opposite the first virtual line VL1.

The cooling efficiency of the green-channel heat dissipating member 43 can therefore be increased, and in turn the efficiency at which the green LED 311G is cooled can be increased.

In the projector 1A, the red-channel heat dissipating member 42 has the multiple fins 42F, between which the first airflow flows along the −Z direction, and the green-channel heat dissipating member 43 has the multiple fins 43F, between which the first airflow flows along the −Z direction. The fins 42F correspond to the first fins, and the fins 43F correspond to the second fins.

According to the configuration described above, the surface area of each of the heat dissipating members 42 and 43 can be readily increased. The cooling efficiency of the heat dissipating members 42 and 43 can therefore be adjusted, for example, by adjusting the numbers of the fins 42F and 43F or adjusting the surface areas of the fins 42F and 43F, and in turn the efficiency at which the LEDs 311R and 311G are each cooled can be adjusted. The temperature of each of the LEDs 311R and 311G can therefore be readily adjusted. Note that the surface area of each of the heat dissipating members 42 and 43 may instead be adjusted by enlarging or reducing the heat dissipating member in at least one of the −X direction and the −Z direction. For example, the surface area of the green-channel heat dissipating member 43 may be adjusted by causing the second region 432 to extend in the +Z direction in a way that the green-channel heat dissipating member 43 has an L-like shape when viewed in the +Y direction.

In the projector 1A, the multiple fins 42F are each formed in a plate-like shape along the XZ plane defined by the −Z direction and the −X direction perpendicular to the −Z direction, and are arranged in the +Y direction perpendicular to each of the −Z direction and the −X direction.

The multiple fins 43F are each formed in a plate-like shape along the YZ plane defined by the −Z direction and the +Y direction, and are arranged in the −X direction.

Note that the −Z direction corresponds to the first direction, that the −X direction corresponds to the second direction, and that the +Y direction corresponds to the third direction.

According to the configuration described above, the direction in which the multiple fins 42F are arranged is perpendicular to the direction in which the multiple fins 43F are arranged when viewed along the −Z direction. According to the configuration described above, a turbulent flow generated when the airflow flows along the multiple fins 42F can be caused to flow to the multiple fins 43F arranged in a different direction, and such a turbulent flow can reduce the thickness of a temperature boundary layer at the multiple fins 43F. That is, the turbulent flow can facilitate the heat transfer from each of the fins 43F to the first airflow. Since the cooling efficiency of the green-channel heat dissipating member 43 can therefore be increased, the efficiency of the heat dissipating members 42 and 43 along with the red-channel heat dissipating member 42, to which the first airflow having a low temperature flows, can be increased.

In the projector 1A, the intervals at which the multiple fins 42F are arranged differ from the intervals at which the multiple fins 43F are arranged.

According to the configuration described above, the cooling efficiency of the heat dissipating members 42 and 43 can be adjusted by adjusting the intervals at which the multiple fins 42F and 43F are arranged, and in turn the efficiency at which the LEDs 311R and 311G are cooled can be adjusted. The temperature of each of the LEDs 311R and 311G can therefore be readily adjusted.

In the projector 1A, the intervals at which the multiple fins 42F are arranged are smaller than the intervals at which the multiple fins 43F are arranged.

According to the configuration described above, even when the red-channel heat dissipating member 42 has a relatively small volume, the surface area of the red-channel heat dissipating member 42 necessary for cooling the red-channel heat dissipating member 42 and in turn cooling the red LED 311R can be ensured.

In the projector 1A, the surface area of the green-channel heat dissipating member 43 is greater than or equal to the surface area of the red-channel heat dissipating member 42.

According to the configuration described above, the heat dissipation efficiency of the green-channel heat dissipating member 43, to which the first airflow having a temperature increased after flowing through the red-channel heat dissipating member 42 flows, can be increased as compared with a case where the surface area of the green-channel heat dissipating member 43 is smaller than the surface area of the red-channel heat dissipating member 42. The temperature of the green LED 311G can therefore be maintained low.

The projector 1A includes the blue light source 31B, the blue-channel heat dissipating member 46, and the second fan 47.

The blue light source 31B includes the blue LED 311B, which generates heat when lit, and the blue LED 311B corresponds to the third heat generator. The blue-channel heat dissipating member 46 corresponds to the third heat dissipating member and dissipates the heat generated by the blue LED 311B. The second fan 47 causes the second airflow to flow to the blue-channel heat dissipating member 46.

The amount of the heat generated by the blue LED 311B is smaller than the amount of the heat generated by the red LED 311R.

The managed temperature of the blue LED 311B is lower than the managed temperature of the green LED 311G.

According to the configuration described above, the blue-channel heat dissipating member 46 dissipates the heat to the second airflow caused to flow by the second fan 47 different from the first fan 44 to cool the blue LED 311B, which generates heat the amount of which is smaller than the amount of the heat generated by the red LED 311R and has a managed temperature lower than the managed temperature of the green LED 311G. According to the configuration described above, the blue-channel heat dissipating member 46 can be cooled independently of the red-channel heat dissipating member 42 and the green-channel heat dissipating member 43. Therefore, the blue-channel heat dissipating member 46 can be effectively cooled, and in turn the blue LED 311B can be effectively cooled. Furthermore, since the cooling difficulty of the blue LED 311B is lower than the cooling difficulty of the red LED 311R and the cooling difficulty of the green LED 311G, only the blue LED 311B can be cooled separately.

In the projector 1A, the red LED 311R, which is the first heat generator, emits the red light. The green LED 311G, which is the second heat generator, emits the green light. The blue LED 311B, which is the third heat generator, emits the blue light.

When the temperature of the red LED exceeds the upper limit of an appropriate temperature range and when the temperature of the red LED falls below the lower limit of the appropriate temperature range, the amount of the light emitted from the red LED drastically decreases. In contrast, the red-channel heat dissipating member 42, which dissipates the heat of the red LED 311R, can be cooled by the first airflow having a temperature lower than that of the first airflow flowing to the green-channel heat dissipating member 43, to which the heat of the green LED 311G is transported. The temperature of the red LED 311R can therefore be readily maintained within the appropriate temperature range.

The projector 1A includes the red light modulating element 34R, the green light modulating element 34G, the blue light modulating element 34B, the light combiner 35, and the projection optical apparatus 36.

The red light modulating element 34R modulates the red light emitted from the red LED 311R. The green light modulating element 34G modulates the green light emitted from the green LED 311G. The blue light modulating element 34B modulates the blue light emitted from the blue LED 311B.

The light combiner 35 combines the red light modulated by the red light modulating element 34R, the green light modulated by the green light modulating element 34G, and the blue light modulated by the blue light modulating element 34B with one another. The projection optical apparatus 36 projects the combined image light from the light combiner 35.

According to the configuration described above, the red light, the green light, and the blue light can be independently modulated by the light modulating elements 34R, 34G, and 34B, respectively. The projector 1A can therefore project high-color-reproducibility image light.

### Second embodiment

A second embodiment of the present disclosure will next be described.

The projector according to the present embodiment is configured in the same manner as the projector 1A according to the first embodiment, but differs therefrom in terms of the position of the first fan. Note that in the following description, portions that are the same or substantially the same as the portions having already been described have the same reference characters, and will not be described.

### Schematic configuration of projector

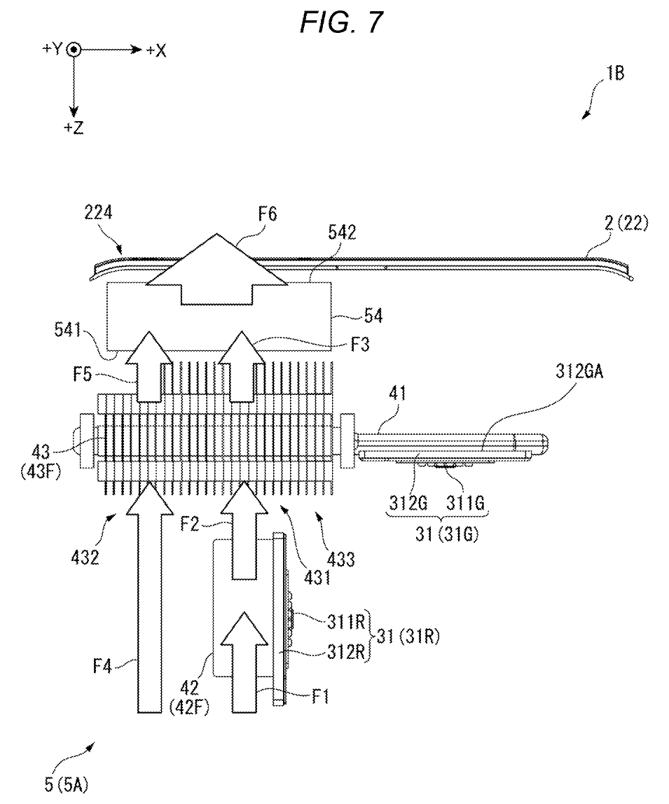

FIG. 7 is a diagrammatic view showing the configuration of a portion of a cooling apparatus 5 in a projector 1B according to the present embodiment.

The projector 1B according to the present embodiment has a configuration and functions that are the same as those of the projector 1A according to the first embodiment except that the cooling apparatus 4 according to the first embodiment is replaced with the cooling apparatus 5 shown in FIG. 7.

The cooling apparatus 5 includes a first cooling system 5A and the second cooling system 4B, and the first cooling system 5A has a configuration and functions that are the same as those of the first cooling system 4A except that the first cooling system 5A includes a first fan 54 shown in FIG. 7 in place of the first fan 44. That is, the first cooling system 5A includes the heat transporting member 41, the red-channel heat dissipating member 42, the green-channel heat dissipating member 43, the first fan 54, and the first duct 45, which is not shown in FIG. 7, and cools each of the red LED 311R of the red light source 31R and the green LED 311G of the green light source 31G.

The first fan 54 is disposed downstream of the red-channel heat dissipating member 42 and the green-channel heat dissipating member 43 in the channel of the first airflow generated by the first fan 54. Specifically, the first fan 54 is disposed at a position shifted in the −Z direction from the green-channel heat dissipating member 43.

In the present embodiment, the first fan 54 is configured with an axial fan having an intake port 541 and an outlet port 542 facing opposite sides.

The intake port 541 faces the positive end in the Z direction, and the outlet port 542 faces the negative end in the Z direction. In other words, the intake port 541 faces the green-channel heat dissipating member 43, and the outlet port 542 faces the exhaust port 224.

When the first fan 54 is driven, the gas in a space on the +Z-side of the first fan 54 is suctioned into the first fan 54 to generate the first airflow flowing along the −Z direction to the red-channel heat dissipating member 42 and the green-channel heat dissipating member 43. The first airflow flows through the heat dissipating members 42 and 43 in the same direction as the first airflow in the first cooling system 4A according to the first embodiment.

The first fan 54 then suctions the first airflows F3 and F5 having flowed to the green-channel heat dissipating member 43, and discharges the suctioned first airflows F3 and F5 as a first airflow F6 out of the exterior enclosure 2 via the exhaust port 224.

The thus configured projector 1B according to the present embodiment can provide the same advantages as the projector 1A according to the first embodiment.

### Variations of embodiments

The present disclosure is not limited to any of the embodiments described above, and variations, improvements, and other modifications to the extent that the object of the present disclosure can be achieved should fall within the scope of the present disclosure.

It is assumed in each of the embodiments described above that the red LED 311R is the first heat generator, that the green LED 311G is the second heat generator, and that the blue LED 311B is the third heat generator, but not necessarily. The heat generators may each not be an LED and may be any element that generates heat and requires cooling.

It is assumed in each of the embodiments described above that the heat transporting member 41 is a heat pipe, but not necessarily. The heat transporting member 41 may be a heat transporting member other than a heat pipe, such as a vapor chamber. Furthermore, the heat transporting member 41 only needs to transport the heat generated by a heat generator to a heat dissipating member provided in accordance with the heat generator, and may be a rod-shaped body or a plate-shaped body made of metal. The heat transporting member 41 may be integrated with the substrate 312G.

It is assumed in each of the embodiments described above that the surface area of the second region 432 of the green-channel heat dissipating member 43 as the second heat dissipating member is greater than the surface area of the first region 431, but not necessarily. The surface area of the second region 432 may be smaller than or equal to the surface area of the first region 431, for example, when a sufficiently low-temperature first airflow can be caused to flow to the second region 432.

It is assumed in each of the embodiments described above that the first region 431 is provided at a position closer to the green light source 31G, which is a heat source, than the second region 432 in the green-channel heat dissipating member 43. In other words, the second region 432 is provided on the side opposite the green light source 31G with the first region 431 therebetween in the green-channel heat dissipating member 43, but not necessarily. In the green-channel heat dissipating member 43, which is the second heat dissipating member, the position of the first region 431 facing the red-channel heat dissipating member 42, which is the first heat dissipating member, and the position of the second region 432, which does not face the red-channel heat dissipating member 42, may be swapped.

It is assumed in each of the embodiments described above that the projectors 1A and 1B each include the first duct 45, which houses the red-channel heat dissipating member 42, the green-channel heat dissipating member 43, and the first fan 44, but not necessarily. The projectors 1A and 1B may each not include the first duct 45.

It is assumed in each of the embodiments described above that the first duct 45 includes the guide 451, which extends in the −X direction from the outlet port 442 of the first fan 44 as extending in the −Z direction and guides the first airflow sent via the outlet port 442 to the second region 432 extending in the −X direction beyond the second virtual line VL2, but not necessarily. For example, when the second region 432 is shifted from the second virtual line VL2 toward the first virtual line VL1, the guide 451 may not extend in the −X direction as extending the −Z direction. For example, the guide 451 may extend along the −Z direction.

The +Z-side end of the guide 451 is not necessarily in contact with the outlet port 442 and may be disposed at a position close to the outlet port 442.

It is assumed in each of the embodiments described above that the red-channel heat dissipating member 42 is disposed between the first virtual line VL1 and the second virtual line VL2, but not necessarily. A portion of the red-channel heat dissipating member 42 may not be disposed between the first virtual line VL1 and the second virtual line VL2.

It is assumed in each of the embodiments described above that the green-channel heat dissipating member 43 extends beyond the second virtual line VL2 toward the side opposite the first virtual line VL1 with the second virtual line VL2 therebetween, but not necessarily. The green-channel heat dissipating member 43 may not extend beyond the second virtual line VL2 as described above. That is, the −X-side end of the second region 432 may be shifted from the second virtual line VL2 toward the first virtual line VL1.

It is assumed in each of the embodiments described above that the red-channel heat dissipating member 42 has the configuration in which the multiple fins 42F along the XZ plane are arranged along the +Y direction. It is further assumed that the green-channel heat dissipating member 43 has the configuration in which the multiple fins 43F are arranged along the YZ plane are arranged along the −X direction. However, the present disclosure is not necessarily configured as described above, and the fins 42F and 43F may be arranged in the same direction.

Furthermore, the red-channel heat dissipating member 42 may be multiple pins protruding along the X-axis in place of the multiple fins 42F. The green-channel heat dissipating member 43 may be pins protruding along the Y-axis in place of the multiple fins 43F.

It is assumed in each of the embodiments described above that the intervals at which the fins 42F as the first fins are arranged are smaller than the intervals at which the fins 43F as the second fins are arranged, but not necessarily. The intervals at which the fins 42F are arranged may be greater than or equal to the intervals at which the fins 43F are arranged.

For example, when the intervals at which the fins 42F are arranged are greater than the intervals at which the fins 43F are arranged, the first airflow readily flows between the multiple fins 42F, so that a loss of the pressure of the first airflow caused by the passage of the first airflow through the red-channel heat dissipating member 42 can be reduced. The first airflow can therefore be readily caused to flow to the green-channel heat dissipating member 43 via the red-channel heat dissipating member 42, so that the cooling efficiency of the green-channel heat dissipating member 43 can be increased, and furthermore, the load on the first fan 44 can be suppressed, so that noise caused by the fan such as wind noise can be reduced.

It is assumed in each of the embodiments described above that the surface area of the green-channel heat dissipating member 43 as the second heat dissipating member is greater than the surface area of the red-channel heat dissipating member 42 as the first heat dissipating member, but not necessarily. For example, when the heat dissipated by the second heat dissipating member is relatively small, the surface area of the second heat dissipating member may be smaller than or equal to the surface area of the first heat dissipating member.

It is assumed in each of the embodiments described above that the projectors 1A and 1B each as the electronic instrument each include the blue LED 311B as the third heat generator, the blue-channel heat dissipating member 46 as the third heat dissipating member, and the second fan 47, which causes the second airflow to flow to the blue-channel heat dissipating member 46, but not necessarily. The electronic instrument according to an aspect of the present disclosure may include none of the third heat generator, the third heat dissipating member, and the second fan. The amount of the heat generated by the third heat generator may not be smaller than the amount of the heat generated by the first heat generator, and the managed temperature of the third heat generator may not be lower than the managed temperature of the second heat generator.

It is assumed in each of the embodiments described above that the blue-channel heat dissipating member 46, to which heat is transferred from the blue LED 311B, dissipates the heat to the second airflow caused to flow by the second fan 47, but not necessarily. The blue-channel heat dissipating member 46 may dissipate the heat to the first airflow caused to flow by the first fan 44. In this case, the blue-channel heat dissipating member 46 may be located upstream of the red-channel heat dissipating member 42 in the channel of the first airflow, may be located between the red-channel heat dissipating member 42 and the green-channel heat dissipating member 43, or may be located downstream of the green-channel heat dissipating member 43.

It is assumed in each of the embodiments described above that the projectors 1A and 1B each include the three light modulating elements 34R, 34G, and 34B, but not necessarily. The present disclosure is also applicable to a projector including two or fewer, or four or more light modulating elements.

It is assumed in each of the embodiments described above that the image projection apparatus 3 has a layout in which the optical paths of the multiple types of color light output from the light sources 31R, 31G, and 31B and entering the light combiner 35 linearly extend, as shown in FIG. 3, but not necessarily. The optical parts that constitute the image projection apparatus 3 and the layout of the optical parts in the image projection apparatus 3 are not limited to those described above.

It is assumed in each of the embodiments described above that the light modulating elements 34R, 34G, and 34B each include a transmissive liquid crystal panel in which the light incident surface and the light exiting surface are different surfaces, but not necessarily. The light modulating elements may include a reflective liquid crystal panel in which a single surface functions as the light incident surface and the light exiting surface. Furthermore, any light modulating element other than the liquid crystal light modulating element such as a device using micromirrors, for example, a digital micromirror device (DMD) may be used as long as the light modulating element is capable of modulating incident light to form image light according to image information.

It is assumed in each of the embodiments described above that the projectors 1A and 1B are each exemplified as the electronic instrument, but not necessarily. The electronic instrument according to an aspect of the present disclosure may be configured as an illuminator or an electronic instrument other than a projector.

### Summary of present disclosure

The present disclosure will be summarized below in the form of additional remarks.

### Additional Remark 1

An electronic instrument including:

a first heat generator configured to generate heat;

a second heat generator configured to generate heat;

a first heat dissipating member configured to dissipate the heat generated by the first heat generator;

a heat transporting member configured to transport the heat generated by the second heat generator;

a second heat dissipating member configured to dissipate the heat transported by the heat transporting member; and

a first fan configured to cause a first airflow to flow along a first direction through the first and second heat dissipating members,

wherein the first heat dissipating member is located upstream of the second heat dissipating member in a channel of the first airflow,

an amount of the heat generated by the first heat generator is smaller than an amount of the heat generated by the second heat generator,

a managed temperature of the first heat generator is lower than a managed temperature of the second heat generator, and

a portion of the second heat dissipating member overlaps with the first heat dissipating member in the first direction.

According to the configuration described above, an airflow having a relatively low temperature can be caused to flow to the first heat dissipating member, which dissipates the heat of the first heat generator, which generates a small amount of heat and has a low managed temperature. The first heat dissipating member and in turn the first heat generator can thus be effectively cooled.

A portion of the second heat dissipating member overlaps with the first heat dissipating member in the first direction, which is the flowing direction of the first airflow, but the other portion of the second heat dissipating member does not overlap with the first heat dissipating member in the first direction. Therefore, a portion of the first airflow flows to the second heat dissipating member via the first heat dissipating member, and the other portion of the first airflow flows to the second heat dissipating member without passing through the first heat dissipating member. As a result, the cooling efficiency of the second heat dissipating member and in turn the efficiency at which the second heat generator is cooled can be increased as compared with a case where only the first airflow having flowed to the first heat dissipating member flows to the second heat dissipating member.

The heat dissipating members can therefore each be effectively cooled by the single fan, so that the size of the electronic instrument can be reduced as compared with a case where multiple fans are provided in accordance with the heat dissipating members. In addition, the number of the fans can be reduced, so that the manufacturing cost of the electronic instrument can be reduced.

### Additional Remark 2

The electronic instrument according to Additional Remark 1, wherein

the second heat dissipating member has

a first region that overlaps with the first heat dissipating member in the first direction, and

a second region that does not overlap with the first heat dissipating member in the first direction,

a surface area of the second region is greater than a surface area of the first region,

a portion of the first airflow flows to the first region via the first heat dissipating member, and

another portion of the first airflow flows to the second region without passing through the first heat dissipating member.

According to the configuration described above, the second region having a surface area greater than the surface area of the first region can be cooled by the first airflow having a low temperature, so that the cooling efficiency of the second heat dissipating member can be increased as compared with a case where the surface area of the second region is smaller than or equal to the surface area of the first region. The cooling efficiency of the second heat dissipating member and in turn the efficiency at which the second heat generator is cooled can therefore be increased.

### Additional Remark 3

The electronic instrument according to Additional Remark 2, wherein

the first fan is disposed upstream of the first heat dissipating member and the second heat dissipating member in the channel of the first airflow, and

the first airflow sent from the first fan directly flows to the second region.

The configuration described above allows the first airflow having a low temperature to flow to the second region as compared with a case where another heat generator or another heat dissipating member is disposed between the first fan and the second region. The cooling efficiency of the second heat dissipating member and in turn the efficiency at which the second heat generator is cooled can therefore be increased.

### Additional Remark 4

The electronic instrument according to Additional Remark 3, further comprising

a guide extending along the first direction and configured to guide the first airflow to the second heat dissipating member,

wherein the first fan has an outlet port via which the first airflow is sent, and

the guide is configured to couple a portion of a side of the outlet port to a portion at a periphery of the second region.

According to the configuration described above, the first airflow sent via the outlet port can be readily caused to flow to the second region. The cooling efficiency of the second heat dissipating member can therefore be increased as compared with a case where the guide is not provided.

### Additional Remark 5

The electronic instrument according to Additional Remark 4, wherein

the first heat dissipating member is disposed between a first virtual line extending in the first direction from one end of the outlet port and a second virtual line extending in the first direction from another end of the outlet port,

the second heat dissipating member extends beyond the second virtual line toward a side opposite the first virtual line with the second virtual line therebetween, and

the guide extends toward a side opposite the first virtual line with the second virtual line therebetween as extending in the first direction.

According to the configuration described above, the second heat dissipating member can be elongated in a direction that intersects with each of the first and second virtual lines. The second region can thus be extended in the direction that intersects with each of the first and second virtual lines, so that the surface area of the second region can be readily increased.

Furthermore, since the guide extends as described above, the first airflow sent via the outlet port can be readily caused to flow to the second heat dissipating member, which extends beyond the second virtual line toward the side opposite the first virtual line.

The cooling efficiency of the second heat dissipating member can therefore be increased.

### Additional Remark 6

The electronic instrument according to any one of Additional Remarks 1 to 5, wherein

the first heat dissipating member includes multiple first fins between which the first airflow flows along the first direction, and

the second heat dissipating member includes multiple second fins between which the first airflow flows along the first direction.

According to the configuration described above, the heat dissipating members each include the multiple fins, so that the surface area of each of the heat dissipating members can be readily increased. The cooling efficiency of each of the heat dissipating members can therefore be adjusted, for example, by adjusting the number of the fins or adjusting the surface area of the fins, and in turn the efficiency at which each of the heat generators is cooled can be adjusted. The temperature of each of the heat generators can therefore be readily adjusted.

### Additional Remark 7

The electronic instrument according to Additional Remark 6, wherein

the multiple first fins are each formed in a plate-like shape along a plane defined by the first direction and a second direction perpendicular to the first direction, and are arranged in a third direction perpendicular to each of the first and second directions, and

the multiple second fins are each formed in a plate-like shape along a plane defined by the first and third directions, and are arranged in the second direction.

According to the configuration described above, the direction in which the multiple first fins are arranged is perpendicular to the direction in which the multiple second fins are arranged when viewed along the first direction. According to the configuration described above, a turbulent flow generated when the first airflow flows along the multiple first fins can be caused to flow to the multiple second fins arranged in a different direction, and such a turbulent flow can reduce the thickness of a temperature boundary layer at the multiple second fins. That is, the turbulent flow can facilitate the heat transfer from each of the second fins to the first airflow. Since the cooling efficiency of the second heat dissipating member can therefore be increased, the efficiency of the heat dissipating members along with the first heat dissipating member, to which the first airflow having a low temperature flows, can be increased.

### Additional Remark 8

The electronic instrument according to Additional Remark 6 or 7, wherein

intervals at which the multiple first fins are arranged differ from intervals at which the multiple second fins are arranged.

According to the configuration described above, the cooling efficiency of the heat dissipating members can be adjusted by adjusting the intervals at which the multiple fins are arranged, and in turn the efficiency at which the heat generators are cooled can be adjusted. The temperature of each of the heat generators can therefore be readily adjusted.

### Additional Remark 9

The electronic instrument according to Additional Remark 8, wherein

the intervals at which the multiple first fins are arranged are smaller than the intervals at which the multiple second fins are arranged.

According to the configuration described above, even when the first heat dissipating member has a relatively small volume, the surface area of the first heat dissipating member necessary for cooling the first heat dissipating member can be ensured.

### Additional Remark 10

The electronic instrument according to any one of Additional Remarks 1 to 9, wherein

a surface area of the second heat dissipating member is greater than or equal to a surface area of the first heat dissipating member.

According to the configuration described above, the heat dissipation efficiency of the second heat dissipating member, to which the first airflow having a temperature increased after flowing through the first heat dissipating member flows, can be increased as compared with a case where the surface area of the second heat dissipating member is smaller than the surface area of the first heat dissipating member. The temperature of the second heat generator can therefore be maintained low.

### Additional Remark 11

The electronic instrument according to any one of Additional Remarks 1 to 10, further including:

a third heat generator configured to generate heat;

a third heat dissipating member configured to dissipate the heat generated by the third heat generator; and

a second fan configured to cause a second airflow to flow to the third heat dissipating member,

wherein an amount of the heat generated by the third heat generator is smaller than the amount of the heat generated by the first heat generator, and

a managed temperature of the third heat generator is lower than the managed temperature of the second heat generator.

According to the configuration described above, the third heat dissipating member dissipates the heat to the second airflow caused to flow by the second fan different from the first fan to cool the third heat generator, which generates heat the amount of which is smaller than the amount of the heat generated by the first heat generator and has a managed temperature lower than the managed temperature of the second heat generator. According to the configuration described above, the third heat dissipating member can be cooled independently of the first heat dissipating member and the second heat dissipating member. Therefore, the third heat dissipating member can be effectively cooled, and in turn the third heat generator can be effectively cooled.

### Additional Remark 12

The electronic instrument according to Additional Remark 11 further including:

a red LED that is the first heat generator and is configured to emit red light;

a green LED that is the second heat generator and is configured to emit green light; and

a blue LED that is the third heat generator and is configured to emit blue light.

According to the configuration described above, the electronic instrument can be configured as an illuminator that outputs the red light, the green light, and the blue light. A small illuminator can therefore be configured.

When the temperature of the red LED exceeds the upper limit of an appropriate temperature range and when the temperature of the red LED falls below the lower limit of the appropriate temperature range, the amount of the light emitted from the red LED drastically decreases. In this case, the first heat dissipating member, which dissipates the heat of the red LED, can be cooled by the first airflow having a temperature lower than that of the first airflow flowing to the second heat dissipating member, to which the heat of the green LED is transported. The temperature of the red LED can therefore be readily maintained within the appropriate temperature range.

### Additional Remark 13

The electronic instrument according to Additional Remark 12 further including:

a red light modulating element configured to modulate the red light emitted from the red LED;

a green light modulating element configured to modulate the green light emitted from the green LED;

a blue light modulating element configured to modulate the blue light emitted from the blue LED;

a light combiner configured to combine the red light modulated by the red light modulating element, the green light modulated by the green light modulating element, and the blue light modulated by the blue light modulating element with one another; and

a projection optical apparatus configured to project the combined light from the light combiner.

According to the configuration described above, the electronic instrument can be configured as a projector.

What is claimed is:

1. An electronic instrument comprising:
a first heat generator configured to generate heat;
a second heat generator configured to generate heat;
a first heat dissipating member configured to dissipate the heat generated by the first heat generator;
a heat transporting member configured to transport the heat generated by the second heat generator;
a second heat dissipating member configured to dissipate the heat transported by the heat transporting member; and
a first fan configured to cause a first airflow to flow along a first direction through the first and second heat dissipating members,
wherein the first heat dissipating member is located upstream of the second heat dissipating member in a channel of the first airflow,
an amount of the heat generated by the first heat generator is smaller than an amount of the heat generated by the second heat generator,
a managed temperature of the first heat generator is lower than a managed temperature of the second heat generator, and
a portion of the second heat dissipating member overlaps with the first heat dissipating member in the first direction.

2. The electronic instrument according to claim 1, wherein
the second heat dissipating member has
a first region that overlaps with the first heat dissipating member in the first direction, and
a second region that does not overlap with the first heat dissipating member in the first direction,
a surface area of the second region is greater than a surface area of the first region,
a portion of the first airflow flows to the first region via the first heat dissipating member, and
another portion of the first airflow flows to the second region without passing through the first heat dissipating member.

3. The electronic instrument according to claim 2, wherein
the first fan is disposed upstream of the first heat dissipating member and the second heat dissipating member in the channel of the first airflow, and
the first airflow sent from the first fan directly flows to the second region.

4. The electronic instrument according to claim 3, further comprising
a guide extending along the first direction and configured to guide the first airflow to the second heat dissipating member,
wherein the first fan has an outlet port via which the first airflow is sent, and
the guide is configured to couple a portion of a side of the outlet port to a portion at a periphery of the second region.

5. The electronic instrument according to claim 4, wherein
the first heat dissipating member is disposed between a first virtual line extending in the first direction from one end of the outlet port and a second virtual line extending in the first direction from another end of the outlet port,
the second heat dissipating member extends beyond the second virtual line toward a side opposite the first virtual line with the second virtual line therebetween, and
the guide extends toward a side opposite the first virtual line with the second virtual line therebetween as extending in the first direction.

6. The electronic instrument according to claim 1, wherein
the first heat dissipating member includes multiple first fins between which the first airflow flows along the first direction, and
the second heat dissipating member includes multiple second fins between which the first airflow flows along the first direction.

7. The electronic instrument according to claim 6, wherein
the multiple first fins are each formed in a plate-like shape along a plane defined by the first direction and a second direction perpendicular to the first direction, and are arranged in a third direction perpendicular to each of the first and second directions, and
the multiple second fins are each formed in a plate-like shape along a plane defined by the first and third directions, and are arranged in the second direction.

8. The electronic instrument according to claim 6, wherein
intervals at which the multiple first fins are arranged differ from intervals at which the multiple second fins are arranged.

9. The electronic instrument according to claim 8, wherein
the intervals at which the multiple first fins are arranged are smaller than the intervals at which the multiple second fins are arranged.

10. The electronic instrument according to claim 1, wherein
a surface area of the second heat dissipating member is greater than or equal to a surface area of the first heat dissipating member.

11. The electronic instrument according to claim 1, further comprising:
a third heat generator configured to generate heat;
a third heat dissipating member configured to dissipate the heat generated by the third heat generator; and
a second fan configured to cause a second airflow to flow to the third heat dissipating member,
wherein an amount of the heat generated by the third heat generator is smaller than the amount of the heat generated by the first heat generator, and
a managed temperature of the third heat generator is lower than the managed temperature of the second heat generator.

12. The electronic instrument according to claim 11, further comprising:
a red LED that is the first heat generator and is configured to emit red light;
a green LED that is the second heat generator and is configured to emit green light; and
a blue LED that is the third heat generator and is configured to emit blue light.

13. The electronic instrument according to claim 12, further comprising:
a red light modulating element configured to modulate the red light emitted from the red LED;
a green light modulating element configured to modulate the green light emitted from the green LED;
a blue light modulating element configured to modulate the blue light emitted from the blue LED;
a light combiner configured to combine the red light modulated by the red light modulating element, the green light modulated by the green light modulating element, and the blue light modulated by the blue light modulating element with one another; and
a projection optical apparatus configured to project the combined light from the light combiner.
